(19) United States
(12) Patent Application Publication
(10) Pub. No.: US 2026/0209420 A1
(43) Pub. Date: Jul. 23, 2026

(54) BIO-BASED HIGH PERFORMANCE (METH)ACRYLATE POLYMERS, FORMULATIONS, AND COMPOSITES WITH CONTROLLED BIODEGRADATION

(71) Applicant: Equilisyn LLC, Berkeley, CA (US)

(72) Inventor: Robert FLEMING, Berkeley, CA (US)

(21) Appl. No.: 19/456,710

(22) Filed: Jan. 22, 2026

Related U.S. Application Data
(60) Provisional application No. 63/748,580, filed on Jan. 23, 2025.

(51) Int. Cl. C08F 290/06; C08K 11/00

(52) U.S. Cl. CPC C08F 290/067; C08K 11/005

(57) ABSTRACT

The invention provides a bio-based urethane (meth)acrylate, including formulations thereof, and products formed therefrom. The bio-based urethane (meth)acrylate is formed, in some embodiments, from the reaction of a bio-based polyol, a bio-based diisocyanate, and an alcohol functional (meth)acrylate that is copolymerized with a (meth)acrylate functionalized isosorbide. In some embodiments, the alcohol functional (meth)acrylate is mixed with at least one of agricultural waste and fibers. In some embodiments, formulations with urethane (meth)acrylate include additives to promote biodegradation.

### STATEMENT OF RELATED CASES

This specification claims priority of U.S. Pat. App. No. 63/748,580 filed Jan. 23, 2025, and which is incorporated by reference herein.

### FIELD OF THE INVENTION

This invention pertains generally to bio-based polymers.

### BACKGROUND

As a consequence of their versatility, low cost, durability, and ability to be produced in almost any shape and color, plastics have become the material of choice for many if not most products. Plastics production has surged over the past 50 years, from 15 million tons in 1964 to 311 million tons in 2014. And production is expected to double over the next 20 years. Over 90% of plastics produced are derived from virgin fossil feedstocks. This represents, for all plastics, about 6% of global oil consumption. If the current strong growth of plastics usage continues as expected, the plastics sector will account for 20% of total oil consumption and 15% of the global annual carbon budget by 2050.

Polymers (plastics) from acrylates are extremely versatile, and are used in a variety of applications, such as transparent windows (e.g., plexiglass), countertops (e.g., Corian®), adhesives used in automotive and composite applications, and coatings used in food packaging. The acrylate group polymerizes very quickly and can be catalytically activated thermally or via ultraviolet radiation.

Urethane (meth)acrylates (UAs) are a specific class of acrylate polymers. They are extremely versatile; they can be formulated to produce good adhesion to substrates, tough and flexible, clear and light stable, as well as moisture and chemical resistant. UAs are used extensively in the coatings industry to coat wood, floors and flexible films. They are used in automotive and electronic applications as protective coatings, sealants, and encapsulants. They are used in adhesive and printing-ink formulations as well. They are also used to make optical components and medical-device enclosures.

Unfortunately, the production of petroleum-based plastics, whether UA-based or otherwise, results in carbon emissions. Moreover, petroleum-based plastics do not break down, thereby polluting the environment. Over time, plastics in the ocean wear down to tiny particles that may find their way into animals, including fish and humans. Studies now link microplastics in the human body to health issues.

For these reasons it is highly desirable to produce plastics from bio-based sources to reduce carbon emissions. It is also highly desirable to produce plastics that are biodegradable and biodegrade into basic components that are not hazardous to people or the environment.

### SUMMARY OF THE INVENTION

Some embodiments of the invention provide a bio-based urethane (meth)acrylate, and formulations and products formed therefrom. Such products include films, coatings, adhesives, composites, and molded plastics. In addition to being substantially bio-based, in some embodiments, formulations with urethane (meth)acrylate include additives to promote biodegradation, and to result in breakdown components that are not hazardous. In this manner, embodiments of the invention address the aforementioned shortcomings related to legacy polymers. Embodiments of the invention meet intended performance attributes and designed use-life. And in accordance with the present teachings, physical performance attributes are “tuned” into the molecular backbone of the base polymers.

Structure I depicts an aliphatic urethane diacrylate oligomer, which is an example of a urethane (meth)acrylate.

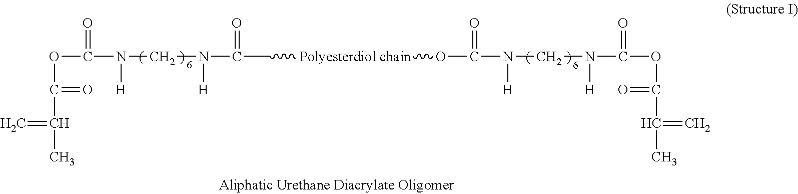

It is notable that in some embodiments of the invention, a bio-based urethane acrylate is synthesized. The term “(meth)acrylate(s)”, as used herein in and in the appended claims, refers to both of methacrylate(s) and acrylate(s), unless context or description otherwise indicates.

In some embodiments, urethane (meth)acrylates are formed by: (1) reacting a low-molecular-weight polyol with a molecule that contains a diisocyanate, and (2) reacting the isocyanate prepolymer resulting from (1) with a hydroxyl functional acrylate. The second reaction adds the acrylic group to the isocyanate prepolymer. In some embodiments, the polyol is reacted with a molecule that contains both an isocyanate group and an acrylic group.

In some embodiments, the invention provides a bio-based urethane (meth)acrylate that is formed from the reaction of a bio-based polyol, a bio-based diisocyanate, and an alcohol functional (meth)acrylate that is copolymerized with a (meth)acrylate functionalized isosorbide. In some of such embodiments, the bio-based polyol is one or more of bio-based polyester polyols, bio-based polyether polyols, and bio-based PHA polyols. In some of such embodiments, at least 70 percent of carbon in the bio-based urethane (meth)acrylate is bio-sourced. In some embodiments, the bio-based urethane (meth)acrylate includes an additive that promotes enzymatic biodegradation when immersed in soil or water. And in some embodiments, the bio-based urethane (meth)acrylate is free of bisphenol A.

In some embodiments, the invention provides a bio-based urethane (meth)acrylate formed from the reaction of a bio-based polyol, a bio-based diisocyanate, and an alcohol functional (meth)acrylate mixed with at least one of agricultural waste and fibers, such as glass fiber, carbon fiber, and/or natural fiber. In some of such embodiments, the agricultural waste is selected from the group consisting of hemp hurd, nut shells, straw, hull, chopped natural fibers, and combinations thereof.

In some embodiments, the invention provides a cross-linked urethane (meth)acrylate copolymer with isosorbide, wherein at least 70 percent of the carbon therein in is bio-sourced. In some of such embodiments, the cross-linked urethane (meth)acrylate copolymer with isosorbide includes an additive that promotes enzymatic biodegradation.

### BRIEF DESCRIPTION OF THE DRAWINGS

FIG. 1 depicts the reaction of a low-molecular-weight polyol with a molecule containing a diisocyanate to form an isocyanate prepolymer.

FIG. 2 depicts the reaction to form the urethane (meth)acrylate, wherein the isocyanate prepolymer (Structure II) is reacted with a molecule containing both a hydroxyl group and a methacrylate group.

FIG. 3 depicts a plot of degradability versus rigidity for PHA as a function of the crystallinity of PHA.

FIG. 4 depicts the reaction of oleic acid and isosorbide to form a biobased polyol prepolymer.

### DETAILED DESCRIPTION

As noted above, in some embodiments, urethane (meth)acrylates are formed by: (1) reacting a low-molecular-weight polyol with a molecule that contains a diisocyanate, and (2) reacting the isocyanate prepolymer resulting from (1) with a hydroxyl functional acrylate. Reaction (2) adds the acrylic group to the isocyanate prepolymer. In some embodiments, the polyol is reacted with a molecule that contains both an isocyanate group and an acrylic group.

### Synthesis of Isocyanate Prepolymer.

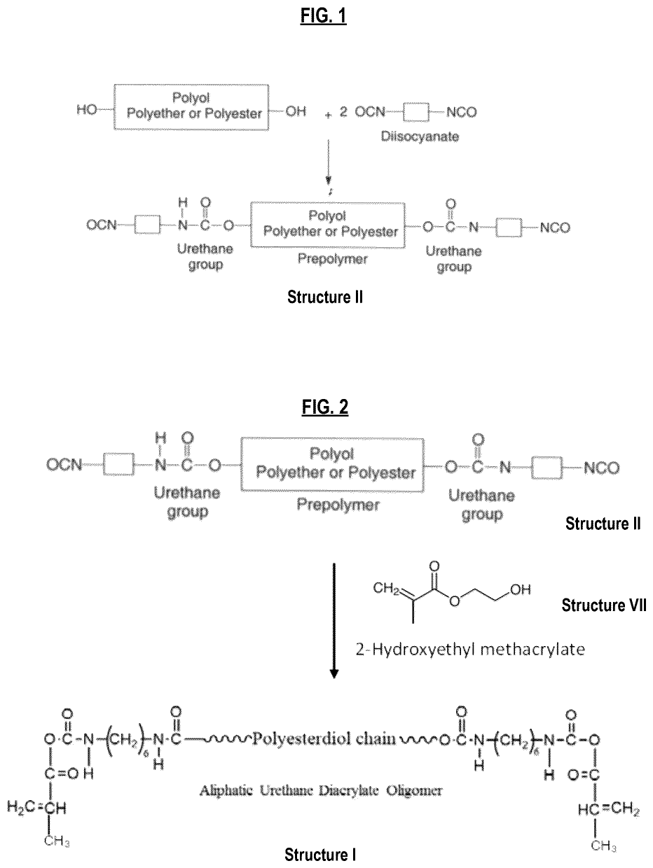

FIG. 1 depicts RXN (1); that is, the reaction of a low-molecular-weight polyol with a molecule containing a diisocyanate to form an isocyanate prepolymer, which is depicted below as Structure II. (Note that the empty rectangles in Structure II below and in the appended drawings are synonymous with the “R” group in organic chemistry, representing the “Rest of the molecule” and consisting of a group of carbon and hydrogen atoms of any size.)

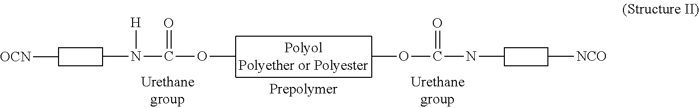

The reaction between the isocyanate and the terminal hydroxyl group on the polyol forms the urethane group, which is polar and hydrogen bonds with its neighboring urethane group; this adds both toughness and adhesion properties.

The polyol can be polyether, polycarbonate, or polyester based. The polyol brings added flexibility to the final properties to a degree that depends on the type of polyol used and its molecular weight. Examples of polyol structures are shown below in Structures III, IV, and V. A polyol in the form of a polyether having the general structure:

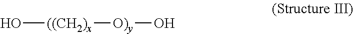

is formed from polymerizing a diol. Alternatively, a polyol in the form of a polyester having the general structure:

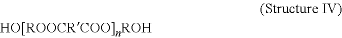

is formed as the reaction product of a diol and a diacid. A polyol may also be formed from a fatty acid that is polymerized by a microorganism to produce a polyhydroxyalkanoate (PHA) of the general structure:

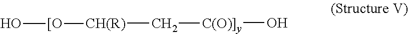

PHA's are readily biodegradable and compostable. Polyols of lower crystallinity (more amorphous) exhibit lower viscosity, making processing easier, and biodegrade faster. The polyol can have a number average molecular weight ranging from 100 to 10,000.

In accordance with the present teachings, the polyol is derived, in part or whole, from bio-based sources. The polyol choice plays a critical role in the properties of the formulation (viscosity for example) as well as the resulting physical properties of the final polymer including the rate of biodegradation of the final polymer. Care is taken to choose the appropriate polyol for the intended manufacturing process, product properties, performance requirements, and intended life cycle. Polyols can comprise of segments of polyether and segments of polyester in the form of a block copolymer.

The diisocyanate has the general structure depicted below as Structure VI.

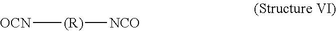

The diisocyanate is reacted with each of the terminal alcohols of the polyol to form the urethane bond. The isocyanate may be an aliphatic isocyanate or an aromatic isocyanate, di-functional or mono-functional. Isocyanates are commonly produced from the reaction of phosgene with alkyl amines, and preferably, the alkyl amines are sourced from a bio-based material. Moreover, it is preferable that the isocyanates are synthesized from routes that do not require phosgene. Aliphatic isocyanates are preferred over aromatic isocyanates because, as between the two, the former produces polymers that are relatively more light-stable and result in biodegradation byproducts that are relatively less hazardous. In some embodiments, the isocyanate has a (meth)acrylate functionality, such as 2-isocyanatoethyl(meth)acrylate, which then directly forms the urethane group with the polyol, and terminates the prepolymer with (meth)acrylate functional group(s).

FIG. 2 depicts RXN 2; that is, the reaction to form the urethane (meth)acrylate. In FIG. 2, the terminal isocyanate of the isocyanate prepolymer (Structure II) is reacted with a molecule, such as 2-hydroxyethylmethacrylate (Structure VII), containing both a hydroxyl group and a methacrylate group.

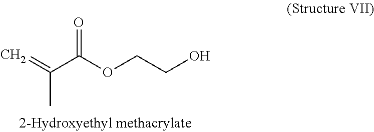

### Bio-Based

In some embodiments, the urethane (meth)acrylate prepolymer is synthesized from a biobased polyol and a biobased isocyanate and hydroxyl functional acrylates that exhibit low to no toxicity in humans or the environment. In some embodiments, formulations of the urethane (meth)acrylate prepolymer include additives that aid in biodegradation of the applied and crosslinked polymer at the end of its life cycle. In some embodiments, formulations of the urethane (meth)acrylate prepolymers contain biobased fillers and/or fibers to modify the physical properties, aesthetics, lower the carbon footprint, lower the cost, and aid in biodegradation.

Many formulations of urethane (meth)acrylates often include Bisphenol A di(meth)acrylates to increase modulus, hardness, toughness, abrasion resistance, high temperature stability, and adhesion. Such formulations have been used extensively in a very broad range of applications, such as protective coatings in automotive, furniture, and flooring applications. They are also used in printing ink, adhesives, and dental compounds.

Bisphenol A di(meth)acrylates (BPADA) and its variants, such as ethoxylated Bisphenol A di(meth)acrylate, and diglycidylether Bisphenol A di(meth)acrylate have a lower melting point, are more soluble, and produce formulations with lower viscosity. For reference, bisphenol A dimethacrylate has a melting point of 72-74 C. They also provide excellent wetting adhesion during coating and produce cured polymers with excellent modulus, toughness, hardness, and chemical resistance. For these reasons, BPADA is used for a wide range of applications. The key molecular features that impart these properties are the two phenol groups that are covalently bonded in the para position by an aliphatic bridge that forms a rigid core molecule, which can be further reacted to add acrylic or epoxy groups. However, Bisphenol A (BPA) is a known endocrine disruptor and is toxic to humans and aquatic organisms. In fact, in 2019, the General Court of the European Union determined that BPA must be listed as a substance of very high concern, given its toxicity for human reproduction. And as recently as Dec. 19, 2024, the European Commission on food safety bans the use of BPA in food contact. As such, it is highly desirable to find a safer replacement for BPA.

In accordance with the present teachings, the biobased urethane (methacrylate) formulations and cross-linked polymers disclosed herein are free of Bisphenol A, yet possess have high modulus, toughness, hardness. In some embodiments, this is accomplished by incorporating (meth)acrylate functionalized isosorbide into the urethane meth (acrylate) formulation and resulting cross-linked polymer. Moreover, (meth)acrylate functional isosorbides also provide greater light stability, relative to BPADA, to the cured cross-linked polymer. Isosorbide is also a non-toxic, rigid, bio-based, dihydroxy core molecule derived from corn biomass, and is biodegradable.

Isosorbide has long been studied in applications such as thermoplastics, epoxy resins, and UV-curable coatings. Structure VIII provides the chemical structure of isosorbide.

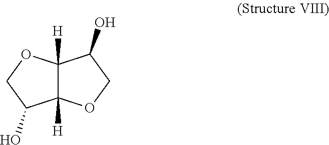

Isosorbide may be reacted with methacrylic anhydride, acrylic acid, or glycidyl (meth)acrylate to produce an acrylate functional molecule. An example of such an acrylate functional molecule is isosorbide dimethacrylate monomer, depicted below as Structure IX. Such acrylate functional molecules are used to replace BPADA in embodiments of the invention.

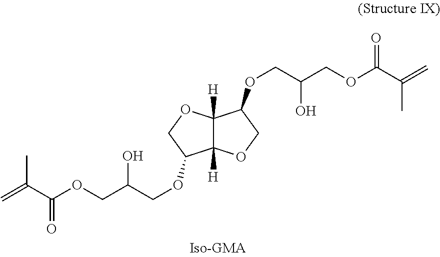 [SMILES: C=C(C)C(=O)OCC(O)CO[C@H]1CO[C@H]2[C@@H]1OC[C@H]2OCC(O)COC(=O)C(=C)C]

The inventor discovered that bio-based polymer formulations can be designed to provide tunable physical performance properties, such as based on the specific type of polyol, the molecular weight of the polyol, the type of diisocyanate, and amount of isosorbide (meth)acrylate, as well as biodegradability.

As used therein, reference to “biodegradable plastics” means plastics that break down into organic components in months or a few years, as opposed to decades or centuries. Biodegradation is a natural process that breaks down everything from yard waste to crude oil. The United States Environmental Protection Agency (EPA) defines it as “a process by which microbial organisms transform or alter (through metabolic or enzymatic action) the structure of chemicals introduced into the environment.” The mechanism varies based on the environment, plastic material, and biodegradation rate. EN 13432 and EN 14995 are standards for the determination of biodegradability and composting of packaging materials. Composting is a specific form of biodegradation that results in compost. In order to be labeled as compostable, bioplastics must biodegrade in a specified time period (typically 90% in 180 days) leaving no toxins in the soil. Other examples of standards for biodegradability and composting are ASTM D6400-23 and ASTM D5338-15 (2021) to name a few. Biodegradation rates of a material are influenced by the bioactivity of the location (e.g., microbes, enzymes, and fungi that are present, etc.), temperature, oxygen and moisture levels.

Embodiments of the invention are designed to be both (1) biobased and (2) meet the designed in-use product lifetimes. In some embodiments, the product resulting from the present formulations are compostable, but in use cases in which long service life is required, the product can be designed to be rendered biodegradable under a specific set of conditions, including adding enzymes, microbes, bacterial, fungi, or other additives to the soil to specifically break down the cross-linked polymer.

In accordance with the present teachings, the fundamental chemistry of the formulations for a given product is designed and selected to match the designed service life of the product. Conditions and times for biodegradation are optimized for the different formulations. For example, formulations and polymers designed for longer product-service lifetimes, such as automotive or wind-turbine composites, may be sent, at the end of product life, to a precision composting environment where the soil, temperature, microbes, and enzymes are precisely controlled to efficiently biodegrade the material. Furthermore, in some embodiments, additives are incorporated into the formulation (and resulting polymer) to assist the biodegradation process. As a consequence of the formulation chemistry, the byproducts of biodegradation are not toxic to humans or the environment.

Some embodiments provide a urethane (meth)acrylate prepolymer that is cross-linked with an di(meth)acrylate functional isosorbide, and which can be formulated into a low viscosity, water-containing or solvent-free formulation. The resulting formulation may then be coated, dried, printed, molded, then cured by UV radiation, IR radiation, or heat to form an optically clear, solid polymer that has greater than 70 percent of carbon from bio-based sources, and more preferably greater than 90 percent. The resulting solid polymer is biodegradable, either “partially” or “readily” biodegradable depending on the use case. For example, it is desirable for food-packaging applications to be “readily biodegradable” (i.e., compostable) to the highest level (i.e., greater than 90 percent of the material converted to CO₂, by weight) in the shortest period of time. In certain other applications (e.g., durable goods in consumer products applications, electronic devices, etc.), biodegradation desirably occurs a slower rate, such as after a year or more. And for yet some other applications, such as structural materials in automotive applications, outdoor furniture and fixtures, tiles, wind-turbine blades, etc., biodegradation may occur over of time period lasting a few years. However, in a controlled industrial composting facility, biodegradation would occur in less than a few years, even less than a year. And regardless of timeframe, biodegradation must not impart toxicity to humans or the environment.

The ISO Standard Description for Bio-based ISO 16620:2015 16620:2015 specifies the general principles and the calculation methods for determining the amount of bio-based content in plastic products, using a radiocarbon method.

A polymer might or might not be biodegradable, irrespective of whether it is bio-based or petroleum based, as shown in Table 1, below. Some embodiments of the invention take pseudo-biodegradable groups traditionally from petroleum-based feedstocks, such as polyurethane (PU) or polyester, and (i) derives them from bio-based feedstocks, while (ii) combining them with bio-based and biodegradable segments, such as PHA (polyhydroxyalkanoates), PCL (polycaprolactone), or PBS (polybutylene succinate). Depending on the use case, “pseudo-biodegradable” may be preferred over “readily biodegradable.” As used herein, the term “readily biodegradable” is synonymous with “compostable.” The term “pseudo biodegradable” is synonymous with “industrial biodegradable,” meaning biodegradable under a set of controlled and optimized conditions. And the term “partially biodegradable” means that not all (<50 percent) of the mass of the product is biodegradable.

TABLE 1
Examples of Non-biodegradable and Biodegradable
Bio-based and Oil-based Polymers

| Non-biodegradable | | Biodegradable | |
|---|---|---|---|
| Non- | Pseudo- | | Marine |
| biodegradable | biodegradable | Compostable | Degradable |

BIO-BASED

| | | | |
|---|---|---|---|
| bioPE | PEF | PLLA | PHA |
| | bioPET | BioPBS | PA4 |

OIL-BASED

| | | | |
|---|---|---|---|
| PE, PP | | | |
| PS, PVC | PET | PBS | |
| PA | PU | PBAT | PCL |

As previously noted, certain plastic products are intended to have a long design and use life. In accordance with the present teachings, when such products reach their end-of-life and are discarded, they should not harm the environment, and preferably will eventually biodegrade, in some cases with the assistance of specific enzymes. In this context, when designing new polymers in accordance with the present teachings, consideration should be given to particular groups that are relatively more or less biodegradable. For example, halogen and polycyclic aromatic groups tend to decrease biodegradability, whereas ester and amide groups tend enhance biodegradability. It is also important that the degradation byproducts of the polymer are not toxic. In this context, it is important to recognize decreasing toxicity does not necessarily accompany “increasing biodegradability;” often, the opposite is true. (Chemical Reviews, 2007, Vol. 107, No. 6.) A nonlimiting embodiment in which the molecules are specifically chosen to produce a cross-link polymer that is readily biodegradable and does not produce toxins after degradation is using 2-hydroxy ethyl methacrylate to form the urethane methacrylate prepolymer, rather than using other molecules, such as 2-hydroxy ethyl acrylate. Thus, in some embodiments, biobased urethane methacrylate prepolymer is synthesized by the reaction of a biobased isocyanate prepolymer with 2-hydroxy ethyl methacrylate.

Bio-based Polyols. As disclosed above, high-performance urethane (meth)acrylates in accordance with the present teachings may be synthesized from bio-based polyols. For example, polyether polyols may be synthesized from bio-based diols, such as butanediol and propanediol. And polyester polyols may be synthesized from biobased diacids and diols. Examples of biobased diacids include sebacic acid, adipic acid, and succinic acid. Biobased polyesters polyols may also be formed from polyhydroxyalkanoates (PHAs). PHAs have been shown to be readily biodegradable whereas polyether polyols are less biodegradable. Mixtures or copolymers of polyether, polyester, and/or PHA based polyols facilitates the formulation of polymers that may be tuned to possess certain physical performance attributes and have a desired rate of biodegradation so as to meet the intended useable lifespan of the product. With respect to biodegradation, polyester backbones are more prone to degradation by hydrolysis, making them relatively more hydro-degradable, whereas polyethers are better degraded by oxidation, rendering them relatively more oxo-degradable. The higher oxygen content of both polyesters and polyethers increase biodegradation over hydrocarbon chains.

Bio-based polyether polyols suitable for use in embodiments of the present invention are commercially available from Wildchem, Danimer Scientific, PolyKey, and BASF. Example of bio-based polyester polyols suitable for use in embodiments of the present invention are commercially available from Evonik Corporation under the tradename Dynacoll® Terra, or Roquette Freres SA under the name Biosuccinium™, biobased polyester polyols are also available from Gantrade, or others. Bio-based polyester polyols are available with a range of molecular weights and viscosities. Optionally, bio-based polyols can be custom synthesized from commercially available bio-based diacids and diols, such as bio-sebacic acid, bio-succinic acid, bio-adipic acid, bio-butanediol, bio-propanediol, and bio-ethylene glycol, for example. Many bio-based polyesters, such as Biosuccinium®, are known to be biodegradable. Other biobased polyols under the trade names Velvetol® and Ecoprol® produced by Weylchem.

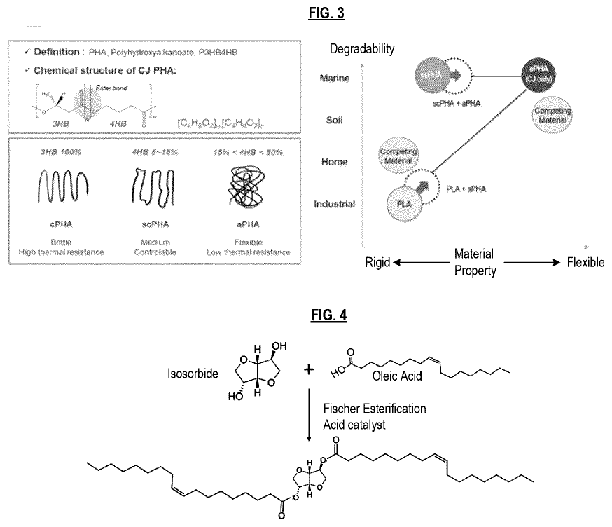

Bio-based polyhydroxyalkanoate (PHA) polyols suitable for use in embodiments of the present invention are commercially available from CJ Biomaterials, Danimer Scientific (Nodax™), VersaMer, Newlight technologies AirCarbon™ Natureworks, Biomer.de, PolyFerm Canada (Versamer), and Mango Materials. PHAs are well known to be readily biodegradable materials. PHA's are readily biodegradable and compostable. Polyols of lower crystallinity (more amorphous) exhibit lower viscosity, making processing easier, and biodegrade faster; an example is shown in FIG. 3 (From CJ Biomaterials, showing an amorphous PHA polyol and resulting performance and biodegradability).

Polyols can be synthesized from unsaturated fatty acids, such as oleic acid, and from natural oils, such as algae oil, soybean oil, hemp oil, olive oil, and the like. For example, for the biobased polyol prepolymer depicted in FIG. 4, two molecules of oleic acid (only one is shown) can be reacted with a bio-based diol, such as butanediol, propanediol, or isosorbide. The double-bond in the oleic ester chain can be directly cross-linked into the polymer network by co-polymerizing with the (meth)acrylates; or the double bond can be oxidized to an alcohol and become a polyol precursor to a urethane acrylate as in the chemistry depicted in FIG. 4. Combinations of the polyols and different types of polyols can be used, including mixtures of polyols and block copolymers of polyols. For example, a low-molecular-weight polytetramethylene glycol may be reacted with a diacid (such as sebacic acid) and a diol (such a butane diol) to make a polyether-polyester block copolymer polyol.

Bio-based Isocyanates. Biobased isocyanates may be obtained from Mitsui Chemical, Covestro, and Algenesis Corp. Mitsui Chemical offers biobased 1,5-pentamethylene diisocyanate and polyisocyanate variants under the tradename Stabio™. Vencorex produces Tolonate™ X FLO 100, a partially bio-based, solvent free and low viscosity aliphatic isocyanate polymer. Covestro produces a partially biobased polyisocyanate under the tradename Desmodur® eco N7300. Evonik produces a line of isophorone diisocyanates (IPDI) under the name Vestanat® IPDI eCO. Conventional isocyanates such as hexamethylene diisocyanate, isophorone diisocyanate, methylenebisdiphenyldiisocyanate, toluene diisocyanate and the like as supplied by Dow Chemicals, Covestro, Huntsman Corporation, BASF, Wanhua Chemical Group, Evonic, Chemtura, and others can also be used in place of or in combination with biobased isocyanates.

Bio-based Composite Parts. The inventor also discovered that high-performance, bio-based composite parts may be produced by combining bio-based urethane acrylates and isosorbide acrylates, with a catalyst and biomass in the form of filler particles and/or natural fibers, and/or glass fibers. These parts may be fabricated by injection molding, resin transfer molding, compression molding, filament winding, or lay-up manufacturing methods.

Biobased composite part examples include, but not limited to, purses, hats, shoes, boots, backpacks, waist packs, wallets, cell phone covers, eyeglass cases, book covers, luggage, sporting good equipment, furniture, bookshelves, cabinets, vehicle parts, computer/tablet/phone housings, tiles, home hardgoods, kitchenware, sculpture, composite panels, etc.

Formulations in accordance with the present teachings comprise (meth)acrylate functional isosorbide monomers, substantially bio-based urethane acrylate prepolymers, and a catalyst for polymerization to form a cross-linked polymer. Optionally, other monomers or prepolymers may be added to modify the viscosity, wetting, adhesion, or resulting physical properties of the resulting formulation, preferably these are also biobased and biodegradable. Optionally, fillers or fibers may be added to the formulation to modify the physical properties of the resulting cross-linked polymer, such as the hardness or toughness. And fillers may be added to alter or improve the optical properties of the resulting cross-linked polymer, such as fillers that provide unique aesthetics to the resulting polymer. Nanoparticles, such as nano-silica, nano-zirconia, or nano-titania, may be added to the formulation to maintain optical clarity, while modifying the refractive index and the hardness of the resulting cross-linked polymer.

Catalysts, which initiate polymerization of the resin, can be activated by ultraviolet (UV) radiation, thermally, or both. Catalysts can also be of the redox type to generate free radicals. The catalyst is added to the resin formulation, forming a “resin system.” In some embodiments, the catalyst is a photo-initiator, which are typically UV activated. Suitable UV photo-initiators include, for example and without limitation, those available under the Speedcure tradename (Arkema Sartomer), including Speedcure BPO, EMK, TPO, TPO-L. BASF also supplies photoinitiators under the Irgacure® tradename, such as Irgacure® 184, 819, and 907. Additionally, photo-initiators suitable for use in conjunction with embodiments of the invention include those available from IGM Resins under the tradename Omnirad, including Omnirad 184, 1173, 127, 1000, ITX, EMK, MBF, OMBB.

In some embodiments, in addition to, or in place of the photo-initiator, a thermal initiator is employed to initiate curing. Suitable thermal initiators include those available from AkzoNoble (acquired by Nouryon), such as Butanox M-50 (ketone peroxide type), Perkadox GB50L or Perkadox L40, Perkadox AMBN, Perkadox AIBN (diacyl peroxide type), or Trigonox 421 (Peroxyesters). Additionally, thermal initiators are available from Arkema under the tradename Luperox®, including activated organic peroxides such as Luperox® A98, Luperox® LP, Luperox® A75, and Luperox® 10. And in some embodiments, iron-based accelerators from Nouryon (US Chicago, IL), available under the tradename Nouryact® may suitably be used. These iron-based catalysts are less sensitive to moisture than cobalt-based catalysts, and hence less susceptible to moisture poisoning. Typically, IR or convection ovens are used to activate the thermal initiators. The initiator(s) (photo, thermal, etc.) will typically represent, collectively, about 0.5 to about 5 weight percent of the resin system.

In order to optimize the formulation and final properties of the cross-linked polymer for the intended manufacturing process and final application, other resins and/or monomers, and/or additives may be used. Suitable resins, include, both biobased resins and mixtures with petroleum-based resins. Preferred commercially available biobased (meth)acrylate resins include those from Arkema Sartomer under the Sarbio™ product lines such as Sarbio 5100, 5103, 5201, 5102, 5106, 6101, 6102, 7106, 7107, and 7205. Also preferred are biobased (meth)acrylate resins from Allnex such as Ebecryl 5850, 5849, 5848, 676, 242, 4491, 4683, R1872, and isobornylacrylate. Generally, methacrylates are preferred over acrylates because methacrylates generally have lower toxicity profiles. Biobased molecules functionalized with a vinyl group may also be used to copolymerize with the acrylates. Biobased diamines can also be used to copolymerize with the acrylates.

Bio-based additives and fillers can be used to increase biodegradability, lower costs, modify viscosity of the formulation, and alter the mechanical and/or optical properties of the final resin. For example, various nut shells are an agricultural waste byproduct that can milled to small particles that can be added to the resin to lower cost, increase bio-content and biodegradability, and impart desirable aesthetic properties. In another example wood waste in the form of sawdust can be milled to a fine particle size and dispersed into the resin to create a desirable color and aesthetic while lowering cost and increasing bio-content and biodegradability. Natural fibers can be chopped to short lengths and added to the formulation to increase modulus, increase bio-content and biodegradability. Chitosan, minerals such as talc and clays, starch, lignin, cellulose, and cellulose derivatives can also be added to enhance properties of the formulation and resulting polymer, or polymer composite.

Bio-based monomers with low viscosity can be added as “reactive diluents” to avoid the use of solvents, which add to the carbon footprint of the system as well presenting solvent removal and solvent disposal issues. Examples of biobased reactive diluents include 1,5-pentanedioldiacrylate under the tradename Denamer 1221 (Nagase Group). Both Arkema (Sartomer) and Allnex offer isobornyl (meth)acrylate, which is another example of a “reactive diluent.”

The resulting cross-linked polymer is advantageously optically transparent in the visible portion of the EM spectrum. It is also desirable that the cross-linked polymer exhibits minimal color, such color often being undesirable in packaging, wood coatings, floor coatings, optical, and composite applications.

In some embodiments, enzymes are added to the polymer formulation or to the composting site at the product's end-of-life. Examples of enzymes that can facilitate biodegradation are those produced by Intropic Materials of Oakland, CA. The low temperatures of processing required to produce formulations and polymers in embodiments of the invention make the incorporation of enzymes for end-of-life degradation a significant advantage. Other additives can be used to facilitate biodegradation, such as BioSphere liquid 302, which is compatible with polyurethanes. Other types of additives can be in the form of agricultural waste such as straw or husks (e.g., corn, soy, wheat, or rice) because they may contain microbes that assist the biodegradation process. Additives that assist the attachment of enzymes, microbes, bacterial, and/or fungi to the surface of the degrading plastic are preferred. This accelerates the enzymatic biodegradation process.

### PROPHETIC EXAMPLES

Table 2 depicts materials and properties used in the following prophetic examples.

TABLE 2
Materials, properties, and weights used in the Examples

| | | | | viscosity | | | |
|---|---|---|---|---|---|---|---|
| | | Polyol | OH | cps at | | | |
| Material | Supplier | MW | value | (temp) | Grams | moles | Example |
| Polyol | | | | | | | |
| PHA (amorphous) | CJ Biomaterials | 2000 | 59 | viscous | 200 | 0.1 | 2 |
| BASF PolyTHF (butanediol) | BASF | 1000 | 107-118 | liquid (30 C.) | 200 | 0.2 | 3 |
| PolyKey (polypropylene oxide) PK06 | PolyKey | 2000 | 59 | 900 (40 C.) | 200 | 0.1 | 1 |
| Isocynate | | | | | | | |
| 1,5-pentamethylene diisocyanate | Mitsui Chemical | 154.17 | | liquid | 30.834 | 0.2 | 1 |
| 2-(Methacryloyloxy)ethyl isocyanate | Millipore Sigma | 155.15 | | liquid | 31.03 | 0.1 | 3 |
| Vestanat IPDI eCO, isophorone diisocycante | Evonik | 222 | | liquid | 44.4 | 0.2 | 2 |

### Example 1

31 grams of 1,5-pentamethylene diisocyanate (available from Mitsui Chemical) is added to a 500 Liter round bottom flask equipped with a heating mantle, overhead mixer, mixing rod with a teflon paddle, thermometer, and funnel. All reactions are performed in a fume hood. Once the diisocyanate is added, the stirring is turned on, and 200 grams of PolyKey PK06 are added slowly. Optionally, 0.5 grams of BiCat Z is added to catalyze the isocyanate-alcohol reaction. The temperature is increased to a temperature in the range of 50° C.-60° C. for 2 hours or until the —OH group is no longer detected by infrared spectroscopy. Next, add 13 grams of 2-hydroxyethyl methacrylate (available from Milipore Sigma) and continue mixing at 50° C.-60° C. for 2 hours or until the —NCO group is no longer detected by infrared spectroscopy. This synthesis forms urethane (meth)acrylate prepolymer. Subsequently, 50 grams of Sarbio 5850 and 50 grams of bis-GMA (structure IX) are added to the urethane acrylate prepolymer.

### Example 1A. Final Formulation and Crosslinked Polymer

1 gram of benzoyl peroxide is added to a jar, and then 6 grams of isobornyl acrylate (available from Allnex) is added and stirred at a temperature in the range of 36° C.-38° C. until dissolved. Then, 60 grams of the mixture of Example 1 is added to the jar, followed by the addition of 0.5 grams of Speedcure TPO. The contents are stirred until dissolved, producing final formulation 1A.

A piece of 7.1-ounce plain weave flax linen is cut to a 51 mm×102 mm sheet and added to an PMMA acrylic mold, machined with a cavity of 2 mm deep, 51 mm wide, and 102 mm long. Final formulation 1A is then added to the mold cavity slowly so all bubbles are removed, then a top PMMA acrylic sheet is added to the top of the mold and clamped shut. The mold is placed under a Dymax Model 5000 light curing system and exposed for 1 minute on each side. The mold is next removed from the UV curing system and placed into an oven for 3 hours at 75° C. The mold is then removed from the oven and the part is removed from the mold.

### Example 1B

Six grams of almond shell waste milled to less than 1 mm (available from Forest Concepts, LLC) is added to final formulation 1A of Example 1A. This mixture is then added to the mold cavity (Example 1A) slowly so all bubbles are removed, and then a top PMMA acrylic sheet is added to the top of the mold and clamped shut. The mold is next placed under a Dymax Model 5000 light curing system and exposed for 1 minute on each side. The mold is removed from the UV curing system and placed into an oven for 3 hours at 75° C. The mold is then removed from the oven and the part is removed from the mold.

### Example 2

44 grams of Vestanat IPDI eCO, a cyclic aliphatic diisocyanate (available from Evonik) is added to a 500 Liter round bottom flask equipped with a heating mantle, overhead mixer, mixing rod with a Teflon paddle, thermometer, and funnel. All reactions are performed in a fume hood. Once the diisocyanate is added, the stirring is turned on and 200 grams of 2000MW aPHA (available from CJBiomaterials) is slowly added. Optionally 0.5 grams of BiCat 8118 is added to catalyze the isocyanate-alcohol reaction. The temperature is increased to a temperature in the range of 50° C.-60° C. for 2 hours or until the —OH group is no longer detected by infrared spectroscopy. Next, 13 grams of 2-hydroxyethyl methacrylate (available from Milipore Sigma) is added and mixing is continued at 50° C.-60° C. for 2 hours or until the —NCO group is no longer detected by infrared spectroscopy. This synthesis forms urethane (meth)acrylate prepolymer. Next, 50 grams of Sarbio 5850 and 50 grams of bis-GMA (structure IX) is added to the urethane acrylate prepolymer.

### Example 2A. Final Formulation and Crosslinked Polymer

1 gram of benzoyl peroxide is added to a jar, and then 6 grams of isobornyl acrylate (available from Allnex) is added and stirred at a temperature in the range of 36° C.-38° C. until dissolved. Next, 60 grams of the mixture in Example 2 is added to the jar, and then 0.5 grams of Speedcure TPO is added to the jar and stirred until dissolved, forming final formulation 2A. Additional isobornyl acrylate may added, as desired, to adjust viscosity. A piece of 18.5 oz plain weave hemp cloth is cut to a 51 mm×102 mm sheet and added to the PMMA acrylic mold of Example 1A. Final formulation 2A is then added to the mold cavity slowly so all bubbles are removed. A top PMMA acrylic sheet is next placed on the top of the mold and clamped shut. The mold is then placed under a Dymax Model 5000 light curing system and exposed for 1 minute on each side. The mold is then removed from the UV curing system and placed into an oven for 3 hours at 75° C. The mold is then removed from the oven and the part is removed from the mold.

### Example 2-B

Six grams of hemp hurd powder (available from Indhemp) milled to less than 1 mm is added to final formulation 2A with mixing. This mixture is then added to the mold cavity of Example 1A slowly so all bubbles are removed, then a top PMMA acrylic sheet was added to the top of the mold and clamped shut. The mold is then placed under a Dymax Model 5000 light curing system and exposed for 1 minute on each side. The mold is then removed from the UV curing system and placed into an oven for 3 hours at 75° C. The mold is next removed from the oven and the part is removed from the mold.

### Example 3

Thirty-one grams of 2-(methyacryloxy)ethylisocyanate is added to a 500 Liter round bottom flask equipped with a heating mantle, overhead mixer, mixing rod with a Teflon paddle, thermometer, and funnel. All reactions are performed in a fume hood. Once the diisocyanate is added, stirring commences and 200 grams of 1000MW bio-based PolyTHF from BASF is added slowly. Optionally, 0.5 grams of BiCat 8118 is added to catalyze the isocyanate-alcohol reaction. The temperature is increased to slowly to a temperature in the range of 50° C.-60° C. for 2 hours or until the —OH and —NCO groups are no longer detected by infrared spectroscopy. This synthesis forms urethane acrylate prepolymer. Next, 50 grams of Sarbio 5850 and 50 grams of bis-GMA (structure IX) are added to the urethane acrylate prepolymer.

### Example 3A. Final Formulation and Crosslinked Polymer

One gram of benzoyl peroxide is added to a jar, and then 6 grams of isobornyl acrylate (available from Allnex) is added and stirred at a temperature in the range of 36° C.-38° C. until dissolved. Then, 60 grams of the mixture in Example 3 is added to the jar, then 0.5 grams of Speedcure TPO is added to the jar and stirred until dissolved, forming final formulation 3A. A piece of 18.5 oz plain weave hemp cloth is cut to a 51 mm×102 mm sheet and added to the PMMA acrylic mold of Example 1A. Final formulation 3 is then added to the mold cavity slowly so all bubbles are removed, and then a top PMMA acrylic sheet is added to the top of the mold and clamped shut. The mold is placed under a Dymax Model 5000 light curing system and exposed for 1 minute on each side. The mold is then removed from the UV curing system and placed into an oven for 3 hours at 75° C. The mold is then removed from the oven and the part is removed from the mold.

### Example 3B

Six grams of hemp hurd powder (from Indhemp) milled to less than 1 mm is added to final formulation 3 with mixing. This mixture is then added to the mold cavity of FIG. 1A slowly so all bubbles are removed. A top PMMA acrylic sheet is then added to the top of the mold and clamped shut. The mold is then placed under a Dymax Model 5000 light curing system and exposed for 1 minute on each side. The mold is then removed from the UV curing system and placed into an oven for 3 hours at 75° C. The mold is then removed from the oven and the part is removed from the mold.

What is claimed:

1. A bio-based urethane (meth)acrylate formed from the reaction of a bio-based polyol, a bio-based diisocyanate, and an alcohol functional (meth)acrylate that is copolymerized with a (meth)acrylate functionalized isosorbide.

2. The bio-based urethane (meth)acrylate of claim 1 wherein the bio-based polyol is selected from the group consisting of bio-based polyester polyols, bio-based polyether polyols, bio-based PHA polyols, and any combinations thereof.

3. The bio-based urethane (meth)acrylate of claim 1 wherein at least 70 percent of carbon in the bio-based urethane (meth)acrylate is bio-sourced.

4. The bio-based urethane (meth)acrylate of claim 1 comprising an additive that promotes enzymatic biodegradation when immersed in soil or water.

5. The bio-based urethane (meth)acrylate of claim 1 wherein the bio-based urethane (meth)acrylate is free of bisphenol A.

6. A bio-based urethane (meth)acrylate formed from the reaction of a bio-based polyol, a bio-based diisocyanate, and an alcohol functional (meth)acrylate mixed with at least one of agricultural waste and fibers, wherein the fibers are selected from the group consisting of glass fiber, carbon fiber, and natural fiber.

7. The bio-based urethane acrylate of claim 6 wherein at least 70 percent of carbon in the bio-based urethane (meth)acrylate is bio-sourced.

8. The bio-based urethane (meth)acrylate of claim 6 wherein the bio-based (meth)urethane acrylate is free of bisphenol A.

9. The bio-based urethane (meth)acrylate of claim 6 comprising an additive that promotes enzymatic biodegradation when immersed in soil or water.

10. The bio-based composite of claim 6 wherein the agricultural waste is selected from the group consisting of hemp hurd, nut shells, straw, hull, chopped natural fibers, and combinations thereof.

11. A cross-linked urethane (meth)acrylate copolymer with isosorbide, wherein at least 70 percent of the carbon therein in is bio-sourced.

12. The cross-linked urethane (meth)acrylate copolymer with isosorbide of claim 11 comprising an additive that promotes enzymatic biodegradation.
